(19) United States
(12) Patent Application Publication
(10) Pub. No.: US 2026/0061916 A1
(43) Pub. Date: Mar. 5, 2026

(54) COMPRESSION ARRAY SYSTEMS AND METHODS

(71) Applicant: LEAR CORPORATION, Southfield, MI (US)

(72) Inventors: Samuel Blair, Rochester, MI (US); David J. Abdella, Farmington Hills, MI (US); Grzegorz Kasperczyk, Warszawa (PL)

(21) Appl. No.: 18/820,573

(22) Filed: Aug. 30, 2024

(51) Int. Cl. B60N 2/90; A61H 9/00

(52) U.S. Cl. CPC B60N 2/976; A61H 9/0078; A61H 2201/0149

(57) ABSTRACT

A system includes a first group of sheets providing a first plurality of rows, each having an inlet and an outlet, and a first column transverse to the first plurality of rows. The first column prevents fluid from flowing from the respective inlets to the respective outlets of the first plurality of rows when the first column is filled with fluid. A second group of sheets provides a second plurality of rows and a second column transverse to the second plurality of rows. The second column prevents fluid from flowing from the respective inlets to the respective outlets of the second plurality of rows when the second column is filled with fluid. A shared inlet valve modulates fluid flow into the one of the first plurality of rows and the one of the second plurality of rows.

### BACKGROUND

Seats may include massage systems for seat occupant comfort.

### BRIEF DESCRIPTION OF THE DRAWINGS

FIG. 1 is a perspective view of an example seat.

FIG. 2 illustrates a first group of sheets of an example air distribution network.

FIG. 3 illustrates a cross sectional view through a portion of the first group of sheets.

FIG. 4 illustrates a cross sectional view through the first group of sheets.

FIG. 5 illustrates a second group of sheets of the example air distribution network.

FIG. 6 illustrates a second group of sheets of the example air distribution network.

FIG. 7 illustrates the example air distribution network.

FIG. 8 schematically illustrates flow through the example air distribution network.

FIG. 9 illustrates openings in an example group of sheets.

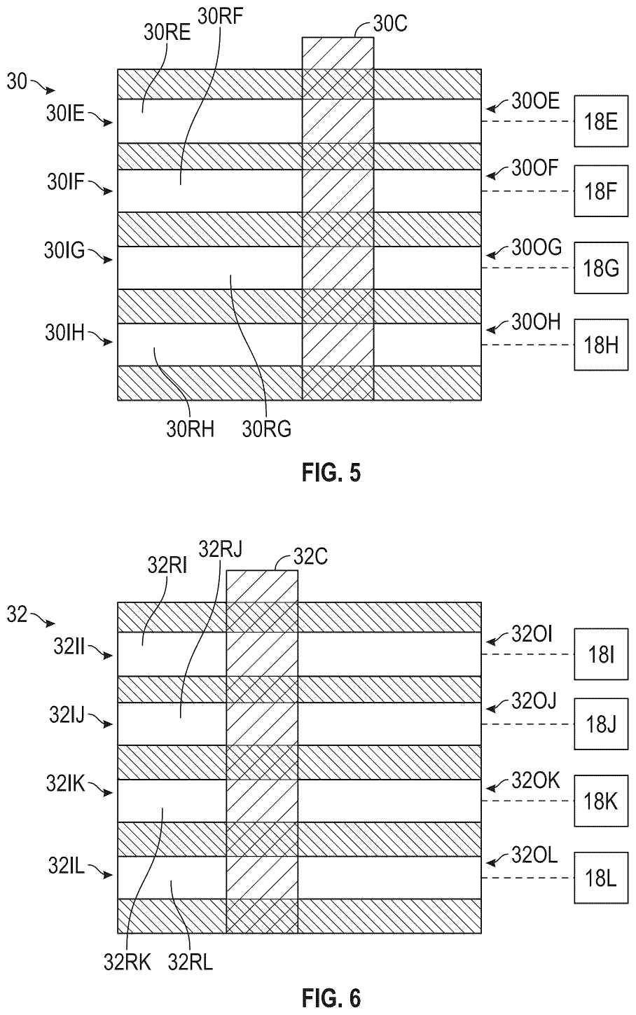

As shown in FIG. 5, a second group of sheets 30 configured similarly to the sheets 26 may similarly provide a second plurality of rows 30RE, 30RF, 30RG, 30RH, in fluid communication with a respective bladder 18E, 18F, 18G, 18H, and a second column 30C transverse to the second plurality of rows 30RE, 30RF, 30RG, 30RH.

As shown in FIG. 6, a second group of sheets 32 configured similarly to the sheets 26, 30 may similarly provide a third plurality of rows 32RI, 32RJ, 32RK, 32RL, in fluid communication with a respective bladder 18I, 18J, 18K, 18L, and a third column 32C transverse to the third plurality of rows 32RI, 32RJ, 32RK, 32RL.

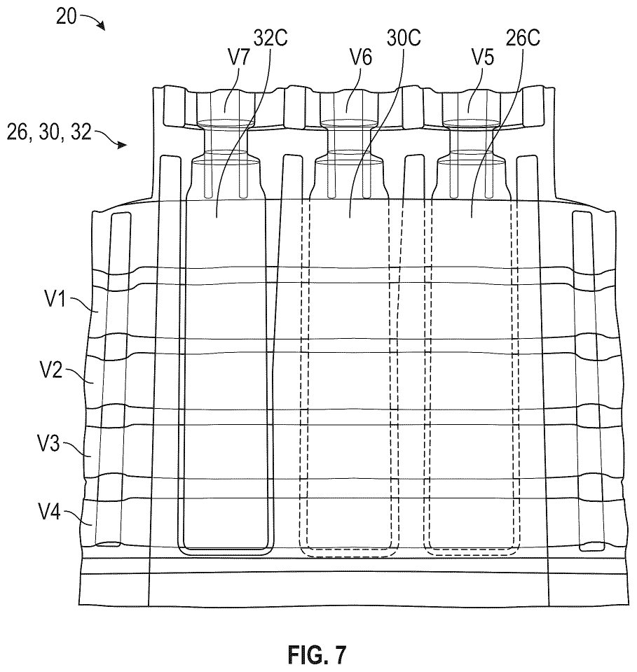

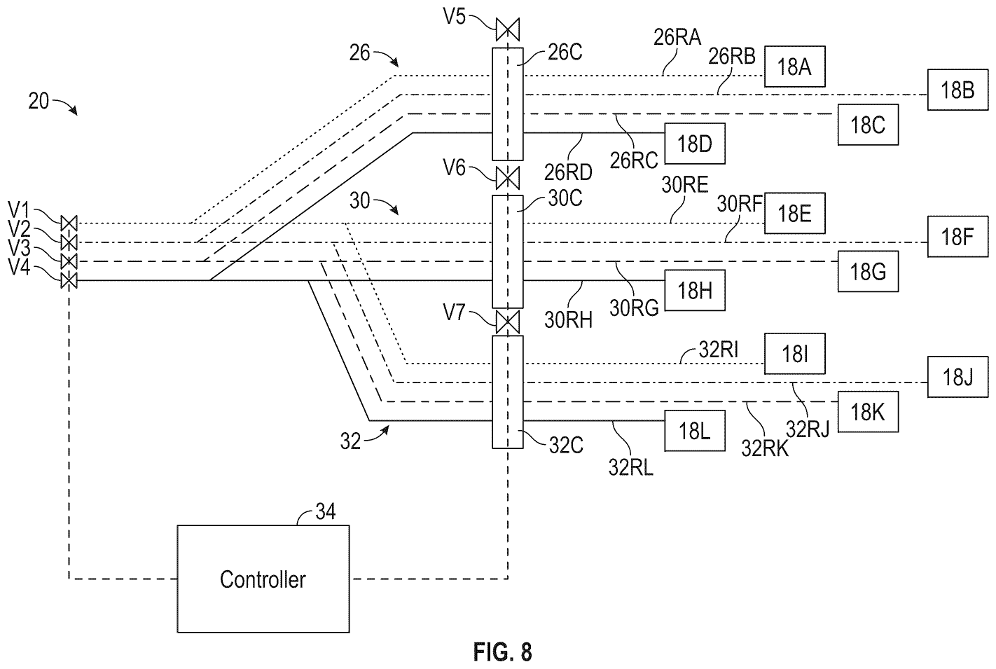

As illustrated in FIGS. 7 and 8, shared inlet valves V1, V2, V3, V4 modulate flow of fluid into the rows of the groups of sheets 26, 30, 32.

FIG. 8 schematically illustrates the fluid flow paths within the example distribution network 20.

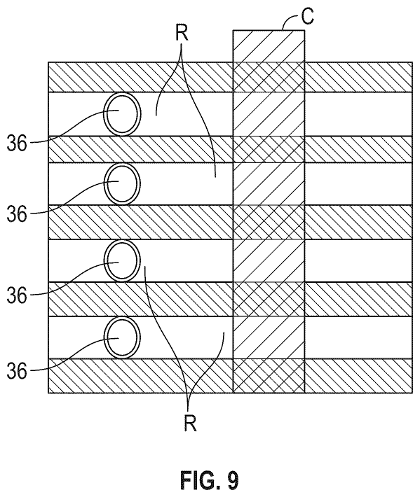

As illustrated in FIG. 9, any of the groups of sheets disclosed herein may include openings 36 at the rows R to provide fluid communication between associated rows R in separate groups of sheets that share an inlet valve.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a vehicle seat with a massage system. More particularly, it relates to a vehicle seat with an air distribution network utilizing one or more groups of sheets.

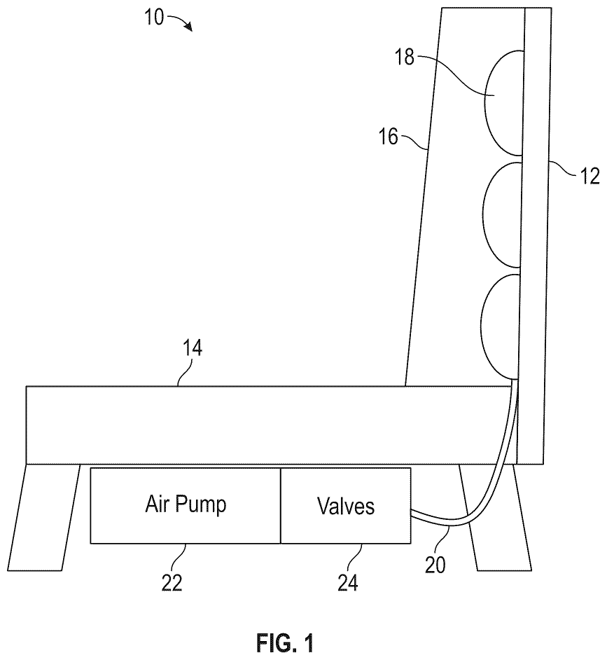

FIG. 1 illustrates a vehicle seat 10. The seat includes a frame 12 which supports a bottom cushion 14 and a back cushion 16. A set of massage bladders 18 is located between the frame and one or more of the cushions. An air distribution network 20 selectively distributes air from an air pump 22 to the massage bladders 18. A valve network 24 directs the air selectively to a subset of the massage bladders 18. An occupant seated in the vehicle seat 10 is able to feel the inflating and deflating massage bladders 18 through the seat cushion.

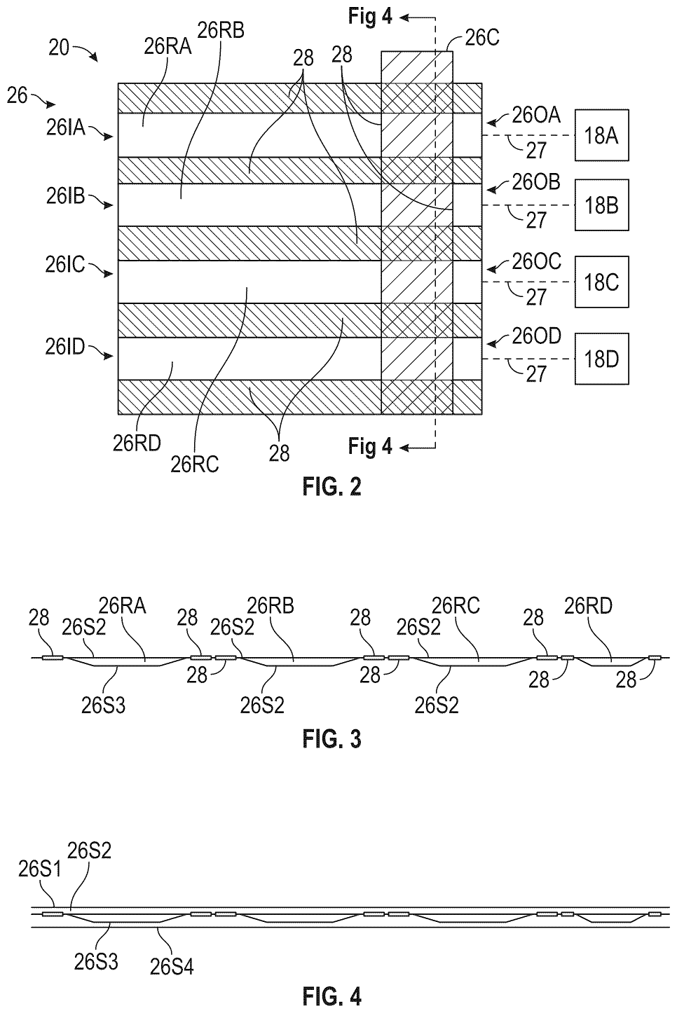

FIG. 2 illustrates at least a portion of an example air distribution network 20. In some implementations, the air distribution network 20 may be used to distribute other fluids such as water, oil, etc. A first group of sheets 26 provides a first plurality of rows 26RA, 26RB, 26RC, 26RD forming flow channels, each having an inlet 26IA, 26IB, 26IC, 26ID and an outlet 26OA, 26OB, 26OC, 26OD and in fluid communication with a respective bladder 18A, 18B, 18C, 18D. In some implementations, the sheets 26 may be of polymeric material, such as Thermo-Plastic Urethane (TPU). The sheets 26 described herein may be joined together by a set of welds 28 to form flow channel rows 26RA, 26RB, 26RC, 26RD, as well as flow channel column 26C. The welds 28 may be formed using any technique, such as high-frequency welding, that functions to create an air-tight joint.

The first group of sheets 26 further provides a first column 26C transverse to the first plurality of rows 26RA, 26RB, 26RC, 26RD. As will be explained further, the first column 26C prevents fluid from flowing from the respective inlets 26IA, 26IB, 26IC, 26ID to the respective outlets 26OA, 26OB, 26OC, 26OD of the first plurality of rows 26RA, 26RB, 26RC, 26RD when the first column 26C is filled with fluid. The cavity provided by the column 26C is fluidly separate from the fluid passages provided by the rows 26RA, 26RB, 26RC, 26RD.

Fluid lines 27 may fluidly connect the outlets 26OA, 26OB, 26OC, 26OD to their respective bladders 18A, 18B, 18C, 18D, as shown schematically. The first group of sheets 26 is arranged fluidly between a pump 22 (see FIG. 1) and bladders 18A, 18B, 18C, 18D.

As shown in FIGS. 3 and 4, in some implementations, the first group of sheets 26 includes four layered thermoplastic polyurethane sheets 26S1, 26S2, 26S3, 26S4. Referring to FIG. 3 (sheets 26S1, 26S4 removed for ease of viewing), the first plurality of rows 26RA, 26RB, 26RC, 26RD may be provided by the second and third sheets 26S2, 26S3 with the welds 28 providing boundaries of the rows 26RA, 26RB, 26RC, 26RD, and the rows 26RA, 26RB, 26RC, 26RD providing sealed and fluidly separate fluid paths.

Referring to FIG. 4 (sheets 26S1, 26S4 shown), the first and fourth sheets 26S1, 26S4 may provide the column 26C (see FIG. 2) and situated between the inlets 26IA, 26IB, 26IC, 26ID and outlets 26OA, 26OB, 26OC, 26OD. In some implementations, the column 26C may be substantially perpendicular to the rows 26RA, 26RB, 26RC, 26RD. As will be explained further, filling the cavity provided by column 26C with air pinches second and third sheets 26S2, 26S3 together to block the fluid path through the rows 26RA, 26RB, 26RC, 26RD, preventing fluid from flowing to the outlets 26OA, 26OB, 26OC, 26OD. The sheet 26S1 may be welded to sheet 26S2, and sheet 26S4 may be welded to sheet 26S3. The sheets 26S1, 26S4 may not span the width of the sheets 26S2, 26S3 in some implementations.

As shown in FIG. 5, a second group of sheets 30 configured similarly to the sheets 26 may similarly provide a second plurality of rows 30RE, 30RF, 30RG, 30RH, in fluid communication with a respective bladder 18E, 18F, 18G, 18H, and a second column 30C transverse to the second plurality of rows 30RE, 30RF, 30RG, 30RH. The second column 30C prevents fluid from flowing from the respective inlets 30IE, 30IF, 30IG, 30IH to the respective outlets 30OE, 30OF, 30OG, 30OH of the second plurality of rows 30RE, 30RF, 30RG, 30RH when the second column 30C is filled with fluid. In the example distribution network 20, the groups of sheets 26, 30 may be arranged in an overlapping stack. As will be discussed further below, a shared inlet valve modulates fluid flow into the one of the first plurality of rows and the one of the second plurality of rows.

As shown in FIG. 6, a second group of sheets 32 configured similarly to the sheets 26, 30 may similarly provide a third plurality of rows 32RI, 32RJ, 32RK, 32RL, in fluid communication with a respective bladder 18I, 18J, 18K, 18L, and a third column 32C transverse to the third plurality of rows 32RI, 32RJ, 32RK, 32RL. The third column 32C prevents fluid from flowing from the respective inlets 32II, 32IJ, 32IK, 32IL to the respective outlets 32OI, 32OJ, 32OK, 32OL of the third plurality of rows 32RI, 32RJ, 32RK, 32RL when the third column 32C is filled with fluid.

In the example distribution network 20, the groups of sheets 26, 30, 32 may be arranged in overlapping stacks (see FIG. 7). As will be discussed below, one or more of the 32RI, 32RJ, 32RK, 32RL may share inlet valves with one or more rows from the groups of sheets 26, 30. In some implementations, each of the first plurality of rows 26RA, 26RB, 26RC, 26RD may share a valve with a separate one of second plurality of rows 30RE, 30RF, 30RG, 30RH and a separate one of the third plurality of rows 32RI, 32RJ, 32RK, 32RL. However, as will be discussed below, the columns 26C, 30C, and 32C allow the distribution network 20 to selectively and individually fill the bladders 18A-18L with fluid with a lesser number of valves than bladders being utilized.

More or fewer than three groups of sheets 26, 30, 32 may be utilized in some implementations. More or fewer than four rows per group of sheets may be utilized in some implementations. Although each of the first, second, and third groups of sheets have an equal number of rows in the illustrative examples, some groups of sheets may have an unequal number of rows in some implementations.

As illustrated in FIGS. 7 and 8, shared inlet valves V1, V2, V3, V4 modulate flow of fluid into the rows of the groups of sheets 26, 30, 32. As shown in FIG. 7, the groups of sheets 26, 30, 32 are arranged in overlapping stacks. Column valves V5, V6, and V7 modulate flows into the respective columns 26C, 30C, 32C. Specifically, valve V5 modulates flow into and out of column 26C, valve V6 modulates flow into and out of column 30C, and valve V7 modulates flow into and out of column 32C.

FIG. 8 schematically illustrates the fluid flow paths within the example distribution network 20. Valve V1 modulates flow into rows 26RA, 30RE, and 32RI. Valve V2 modulates flow into rows 26RB, 30RF, and 32RJ. Valve V3 modulates flow into rows 26RC, 30RG, 32RK. Valve V4 modulates flow into rows 26RD, 30RF, and 32RL. The columns 26C, 30C, and 32C allow the distribution network 20 to selectively and individually fill the bladders 18A-18L with fluid with a lesser number of valves than bladders being utilized.

Each of the bladders 18A-18L may be individually filled without filling the other of the bladders 18A-18L. For example, to selectively fill bladder 18A, valve V1 is opened, and valves V2, V3, V4 are closed. Closing valves V2, V3, V4 prevents flow to bladders 18B-18D, 18F-18H, and 18J-18L. Valves V6 and V7 are opened to pinch and prevent flow through rows 30RE and 32RI, thereby preventing flow to bladders 18E and 18I. Valve V5 is closed to allow flow through row 26RA to bladder 18A.

As another example, to selectively fill bladder 18B, valve V2 is opened, and valves V1, V3, and V4 are closed. Valves V6 and V7 are opened to pinch and prevent flow through rows 30RF and 32RJ. Valve V5 is closed to allow flow through row 26RB to bladder 18B.

As another example, to selectively fill bladder 18G, valve V3 is opened, and valves V1, V2, and V4 are closed. Valves V5 and V7 are opened to pinch and prevent flow through rows 26RC and 32RK. Valve V6 is closed to allow flow through row 30RG to bladder 18G.

As another example, to selectively fill bladder 18L, valve V4 is opened and valves V1, V2, V3 are closed. Valves V5 and V6 are opened to pinch and prevent flow through rows 26RD and 30RH. Valve V7 is closed to allow flow through row 32RL to bladder 18L.

The remaining bladders may be individually filled in a similar manner. Said another way, to fill a bladder, the associated one of valves V1, V2, V3, V4 is opened, and the rest of valves V1, V2, V3, V4 are closed. The associated column valve V5, V6, V7 is closed, and the other of the column valves V5, V6, V7 are opened.

In implementations, the plurality of bladders 18A-18L comprise discrete inflatable/deflatable pouches or cells for massage and/or lumbar/bolster seat features that are to be associated with the seat cushion 14, 16. In some implementations, ventilation of the bladders 18A-18L may be done back through the same fluid paths described above.

In some implementations, as shown, N inlet valves and M column valves may be used to individually control flow to N×M bladders. For example, four inlet valves V1, V2, V3, V4 and three column valves V5, V6, V7 are used to individually control flow to 12 bladders 18A-18L. Less than one valve per bladder is therefore utilized. Other numbers of valves and/or bladders may be utilized in accordance with this disclosure.

As shown schematically, one or more controllers 34 may control the disclosed valves to supply fluid flow from the pump 22 (see FIG. 1) to a selected control fluid line.

In implementations, the one or more controllers 34 can include a processor, memory, and one or more input and/or output (I/O) device interface(s) that are communicatively coupled via a local interface. The local interface can include, for example but not limited to, one or more buses and/or other wired or wireless connections. The one or more controllers 34 may be a hardware device for executing software, particularly software stored in memory. The one or more controllers C can be a custom made or commercially available processor, a central processing unit (CPU), an auxiliary processor among several processors associated with the computing device, a semiconductor based microprocessor (in the form of a microchip or chip set) or generally any device for executing software instructions. The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions. The one or more controllers 34 can be configured to execute software stored within the memory, to communicate data to and from the memory, and to generally control operations of the computing device pursuant to the software.

As illustrated in FIG. 9, any of the groups of sheets disclosed herein may include openings 36 at the rows R to provide fluid communication between associated rows R in separate groups of sheets that share an inlet valve. The openings 36 are located upstream of the columns C. In some implementations, the middle group or groups of sheets may have openings 36 in both sheets forming the rows R, while the outer groups of sheets may have openings 36 only on the inner sheets forming the rows R. Respective openings 36 may be aligned across groups of sheets and sealingly connected. In some implementations, the opening 36 may provide any of the inlets to the rows R disclosed herein. Additionally or alternatively, one group of rows R may have separate openings providing inlets to which the shared valve is coupled.

A method according to any of the disclosed implementations may include inflating one of a plurality of bladders disposed within a seat. The inflating may include selecting a row in a first group of sheets having an outlet in fluid communication with the one of the plurality of bladders, opening a valve associated with a first inlet of the selected row, pumping fluid into the selected row across the opened valve, and inflating a column in a second group of sheets having a second set of one or more outlets associated with other of the plurality of bladders to prevent fluid from flowing through a second row of the second group of sheets in fluid communication with the first inlet to the second set of one or more outlets.

In some aspects, a system may include a first group of sheets providing a first plurality of rows, each having an inlet and an outlet, and a first column transverse to the first plurality of rows, the first column preventing fluid from flowing from the respective inlets to the respective outlets of the first plurality of rows when the first column is filled with fluid; a second group of sheets providing a second plurality of rows and a second column transverse to the second plurality of rows, the second column preventing fluid from flowing from the respective inlets to the respective outlets of the second plurality of rows when the second column is filled with fluid; and a shared inlet valve provided at an inlet of one of the first plurality of rows, the shared inlet valve modulating fluid flow into the one of the first plurality of rows and the one of the second plurality of rows.

In some aspects, a system may include a third group of sheets providing a third plurality of rows and a third column transverse to the third plurality of rows, the third column preventing fluid from flowing from the respective inlets to the respective outlets of the third plurality of rows when the third column is filled with fluid, the shared inlet valve modulating fluid flow into the one of the third plurality of rows.

In some aspects, the first group of sheets and the second group of sheets include thermoplastic polyurethane sheets.

In some aspects, the first group of sheets are welded to provide the first plurality of rows and the first column.

In some aspects, the first plurality of rows includes at least three rows.

In some aspects, the first group of sheets includes first, second, third, and fourth thermoplastic polyurethane sheets, wherein the second and third sheets are welded to one another to provide the first plurality of rows, and the first sheet is welded to the second sheet and the fourth sheet is welded to the third sheet to provide the first column.

In some aspects, a system may include a second shared inlet valve provided at an inlet of a second of the first plurality of rows, the second shared inlet valve modulating fluid flow into the second of the first plurality of rows and the second of the second plurality of rows.

In some aspects, a system may include a third valve provided at an inlet of the first column, the third valve modulating fluid flow into the first column; and a fourth valve provided at an inlet of the second column, the fourth valve modulating fluid flow into the second column.

In some aspects, a system may include a third group of sheets providing a third plurality of rows and a third column transverse to the third plurality of rows, the third column preventing fluid from flowing from the respective inlets to the respective outlets of the third plurality of rows when the third column is filled with fluid, wherein the shared inlet valve modulates fluid flow into the one of the third plurality of rows, and the second shared inlet valve modulates fluid flow into the second of the third plurality of rows; and a fifth valve provided at an inlet of the third column, the fifth valve modulating fluid flow into the third column.

In some aspects, a system may include a third shared inlet valve provided at an inlet of a third of the first plurality of rows, the third shared inlet valve modulating fluid flow into the third of the first plurality of rows and the third of the second plurality of rows.

In some aspects, a system may include a vehicle seat; a plurality of bladders disposed within the vehicle seat; and a valve system modulating fluid flowing to the plurality of bladders, the valve system including: a first group of layered sheets providing a first plurality of rows, each having an inlet and an outlet, and a first column transverse to the first plurality of rows, the first column preventing fluid from flowing from the respective inlets to the respective outlets of the first plurality of rows when the column is filled with fluid; a second group of sheets providing a second plurality of rows and a second column transverse to the second plurality of rows, the second column preventing fluid from flowing from the respective inlets to the respective outlets of the second plurality of rows when the column is filled with fluid, wherein each of the outlets of the first and second group of sheets is associated with one of the plurality of bladders; and a shared inlet valve provided at an inlet of one of the first plurality of rows, the shared inlet valve modulating fluid flow into the one of the first plurality of rows and the one of the second plurality of rows.

In some aspects, a system may include a pump moving the fluid through the valve system to the plurality of bladders.

In some aspects, the techniques described herein relate to a system, wherein the vehicle seat includes a seat base and a seat back, and the plurality of bladders and the valve system are disposed in the seat back.

In some aspects, a system may include a second shared inlet valve provided at an inlet of a second of the first plurality of rows, the second shared inlet valve modulating fluid flow into the second of the first plurality of rows and the second of the second plurality of rows.

In some aspects, a system may include a third valve provided at an inlet of the first column, the third valve modulating fluid flow into the first column; and a fourth valve provided at an inlet of the second column, the fourth valve modulating fluid flow into the second column.

In some aspects, a system may include a third group of sheets providing a third plurality of rows and a third column transverse to the third plurality of rows, the third column preventing fluid from flowing from the respective inlets to the respective outlets of the third plurality of rows when the third column is filled with fluid, wherein the shared inlet valve modulates fluid flow into the one of the third plurality of rows, and the second shared inlet valve modulates fluid flow into the second of the third plurality of rows; and a fifth valve provided at an inlet of the third column, the fifth valve modulating fluid flow into the third column.

In some aspects, a system may include a third shared inlet valve provided at an inlet of a third of the first plurality of rows, the third shared inlet valve modulating fluid flow into the third of the first plurality of rows and the third of the second plurality of rows.

In some aspects, a method may include inflating one of a plurality of bladders disposed within a seat, the inflating including: selecting a row in a first group of sheets having an outlet in fluid communication with the one of the plurality of bladders; opening a valve associated with a first inlet of the selected row; pumping fluid into the selected row across the opened valve; and inflating a column in a second group of sheets having a second set of one or more outlets associated with other of the plurality of bladders to prevent fluid from flowing through a second row of the second group of sheets in fluid communication with the first inlet to the second set of one or more outlets.

In some aspects, the method may include inflating a column in a third group of sheets having a third set of one or more outlets associated with other of the plurality of bladders to prevent fluid from flowing through a third row of the third group of sheets in fluid communication with the first inlet and the second inlet to the a third set of one or more outlets.

In some aspects, the second group of sheets includes first, second, third, and fourth thermoplastic polyurethane sheets, wherein the second and third sheets are welded to one another to provide a plurality of rows providing the second set of one or more outlets, and the first sheet is welded to the second sheet and the fourth sheet is welded to the third sheet to provide the column.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A system, comprising:
a first group of sheets providing a first plurality of rows, each having an inlet and an outlet, and a first column transverse to the first plurality of rows, the first column preventing fluid from flowing from the respective inlets to the respective outlets of the first plurality of rows when the first column is filled with fluid;
a second group of sheets providing a second plurality of rows and a second column transverse to the second plurality of rows, the second column preventing fluid from flowing from the respective inlets to the respective outlets of the second plurality of rows when the second column is filled with fluid; and
a shared inlet valve provided at an inlet of one of the first plurality of rows, the shared inlet valve modulating fluid flow into the one of the first plurality of rows and the one of the second plurality of rows.

2. The system of claim 1, comprising:
a third group of sheets providing a third plurality of rows and a third column transverse to the third plurality of rows, the third column preventing fluid from flowing from the respective inlets to the respective outlets of the third plurality of rows when the third column is filled with fluid, the shared inlet valve modulating fluid flow into the one of the third plurality of rows.

3. The system of claim 1, wherein the first group of sheets and the second group of sheets comprise thermoplastic polyurethane sheets.

4. The system of claim 3, wherein the first group of sheets are welded to provide the first plurality of rows and the first column.

5. The system of claim 1, wherein the first plurality of rows includes at least three rows.

6. The system of claim 1, wherein the first group of sheets comprises first, second, third, and fourth thermoplastic polyurethane sheets, wherein the second and third sheets are welded to one another to provide the first plurality of rows, and the first sheet is welded to the second sheet and the fourth sheet is welded to the third sheet to provide the first column.

7. The system of claim 1, comprising:
a second shared inlet valve provided at an inlet of a second of the first plurality of rows, the second shared inlet valve modulating fluid flow into the second of the first plurality of rows and the second of the second plurality of rows.

8. The system of claim 7, comprising:
a third valve provided at an inlet of the first column, the third valve modulating fluid flow into the first column; and
a fourth valve provided at an inlet of the second column, the fourth valve modulating fluid flow into the second column.

9. The system of claim 8, comprising:
a third group of sheets providing a third plurality of rows and a third column transverse to the third plurality of rows, the third column preventing fluid from flowing from the respective inlets to the respective outlets of the third plurality of rows when the third column is filled with fluid, wherein the shared inlet valve modulates fluid flow into the one of the third plurality of rows, and the second shared inlet valve modulates fluid flow into the second of the third plurality of rows; and
a fifth valve provided at an inlet of the third column, the fifth valve modulating fluid flow into the third column.

10. The system of claim 8, comprising:
a third shared inlet valve provided at an inlet of a third of the first plurality of rows, the third shared inlet valve modulating fluid flow into the third of the first plurality of rows and the third of the second plurality of rows.

11. A system, comprising:
a vehicle seat;
a plurality of bladders disposed within the vehicle seat; and
a valve system modulating fluid flowing to the plurality of bladders, the valve system comprising:
a first group of layered sheets providing a first plurality of rows, each having an inlet and an outlet, and a first column transverse to the first plurality of rows, the first column preventing fluid from flowing from the respective inlets to the respective outlets of the first plurality of rows when the column is filled with fluid;
a second group of sheets providing a second plurality of rows and a second column transverse to the second plurality of rows, the second column preventing fluid from flowing from the respective inlets to the respective outlets of the second plurality of rows when the column is filled with fluid, wherein each of the outlets of the first and second group of sheets is associated with one of the plurality of bladders; and
a shared inlet valve provided at an inlet of one of the first plurality of rows, the shared inlet valve modulating fluid flow into the one of the first plurality of rows and the one of the second plurality of rows.

12. The system of claim 11, comprising:
a pump moving the fluid through the valve system to the plurality of bladders.

13. The system of claim 11, wherein the vehicle seat includes a seat base and a seat back, and the plurality of bladders and the valve system are disposed in the seat back.

14. The system of claim 11, comprising:
a second shared inlet valve provided at an inlet of a second of the first plurality of rows, the second shared inlet valve modulating fluid flow into the second of the first plurality of rows and the second of the second plurality of rows.

15. The system of claim 14, comprising:
a third valve provided at an inlet of the first column, the third valve modulating fluid flow into the first column; and
a fourth valve provided at an inlet of the second column, the fourth valve modulating fluid flow into the second column.

16. The system of claim 15, comprising:
a third group of sheets providing a third plurality of rows and a third column transverse to the third plurality of rows, the third column preventing fluid from flowing from the respective inlets to the respective outlets of the third plurality of rows when the third column is filled with fluid, wherein the shared inlet valve modulates fluid flow into the one of the third plurality of rows, and the second shared inlet valve modulates fluid flow into the second of the third plurality of rows; and
a fifth valve provided at an inlet of the third column, the fifth valve modulating fluid flow into the third column.

17. The system of claim 15, comprising:
a third shared inlet valve provided at an inlet of a third of the first plurality of rows, the third shared inlet valve modulating fluid flow into the third of the first plurality of rows and the third of the second plurality of rows.

18. A method, comprising:
inflating one of a plurality of bladders disposed within a seat, the inflating comprising:
selecting a row in a first group of sheets having an outlet in fluid communication with the one of the plurality of bladders;
opening a valve associated with a first inlet of the selected row;
pumping fluid into the selected row across the opened valve; and
inflating a column in a second group of sheets having a second set of one or more outlets associated with other of the plurality of bladders to prevent fluid from flowing through a second row of the second group of sheets in fluid communication with the first inlet to the second set of one or more outlets.

19. The method of claim 18, the method comprising:
inflating a column in a third group of sheets having a third set of one or more outlets associated with other of the plurality of bladders to prevent fluid from flowing through a third row of the third group of sheets in fluid communication with the first inlet and the second inlet to the a third set of one or more outlets.

20. The method of claim 18, wherein the second group of sheets comprises first, second, third, and fourth thermoplastic polyurethane sheets, wherein the second and third sheets are welded to one another to provide a plurality of rows providing the second set of one or more outlets, and the first sheet is welded to the second sheet and the fourth sheet is welded to the third sheet to provide the column.
